(19) United States
(12) Patent Application Publication
(10) Pub. No.: US 2002/0155250 A1
(43) Pub. Date: Oct. 24, 2002

(54) Glazing panel closure

(75) Inventor: John Michael Riley, Tarporley (GB)

Correspondence Address: Gregory J. Lunn, Wood, Herron & Evans, L.L.P., 2700 Carew Tower, 441 Vine Street, Cincinnati, OH, 45202-2917, US

(73) Assignee: Park Lane Conservatories Ltd.

(21) Appl. No.: 10/059,671

(22) Filed: Jan. 29, 2002

(30) Foreign Application Priority Data
Apr. 23, 2001 (GB) 0109959.7

(51) Int. Cl. B32B 3/06

(52) U.S. Cl. 428/99; 428/122; 428/119

(57) ABSTRACT

A closure device (1) for a double skin glazing panel (9) is of generally U-shape and has beads (8) on the inner surface of the free ends of the arms (2, 3).

### BACKGROUND

The invention relates to a device for closing one end of multi-skinned glazing panels, together with a method of closing the ends of such panels using the device.

Glazing panels, such as those used in conservatory roofs, are usually formed of plastics or glass transparent sheeting. Generally, roof glazing panels comprise at least two sheets, known as skins, which are joined by intermediate members to form longitudinal ducts. The free ends of these ducts are open, and if the ends are left open within a roofing structure, dust and insects become trapped between the skins, detracting from the visual quality of the roofing and causing other problems.

The free ends of the ducts are usually covered with a porous material such as breather tape, to allow condensation formed within the panels to escape, but to exclude dust and insects. End caps are then placed over the free ends of the ducts to prevent rain water and condensation formed on the outside of the skins from flowing into the ducts.

One known end cap is of channel section profile, the glazing panel being received in the channel. One arm of the channel includes a co-extruded gasket which extends away from and beyond its free edge.

### SUMMARY OF THE INVENTION

It is one object of the invention to provide an end closure device of improved performance.

Accordingly to one aspect of the present invention, there is provided a device for closing one end of a glazing panel, the device comprising a body of generally channel cross-sectional shape having two arm portions joined by a bight portion; the arm portions being adapted to overlie the end portions of opposite sides of the glazing panel, gripping means being present on the inner surface of the arms, each arm gripping the adjacent panel surface, the gripping means generally facing each other and being within the bounds of the device.

Preferably the gripping means are comprised of a waterproof, resilient, gasket material. The gasket material is preferably a synthetic plastic material or the like. The gasket material may be formed as one or more resilient beads. The gasket material may be co-extruded with the body of the device or bonded to the body of the device with a suitable adhesive or the like.

In a preferred embodiment the device includes stop members comprising ribs located on the inner surface of each arm portion close to the bight portion, whereby a space is created between the end of the glazing panel and the bight portion.

Preferably the bight portion has a lateral extension which in use is downwardly extending so that water droplets will fall away from the free ends of the arm portions.

According to a second aspect of the invention, there is provided a method of closing one end of a glazing panel by receiving the free end of the glazing panel in a device having a body comprising a generally channel cross-sectional shape having two arm portions joined by a bight portion; the arm portions being adapted to overlie the end portions of opposite sides of the glazing panel, gripping means being present on the inner surface of the arms, each arm gripping the adjacent panel surface, the gripping means generally facing each other and being within the bounds of the device, the method comprising engaging the device with an edge portion of the panel until the arm portions overlie the end portions of opposite sides of the panel.

In order that the invention may be well understood it will now be described by way of illustration only with reference to the accompanying diagrammatic drawings, in which:

### BRIEF DESCRIPTION OF DRAWINGS

FIG. 1 is a cross-sectional view of one end closure device of the invention; and

FIG. 2 is the end closure device of FIG. 1, showing the device engaged with an edge portion of a glazing panel.

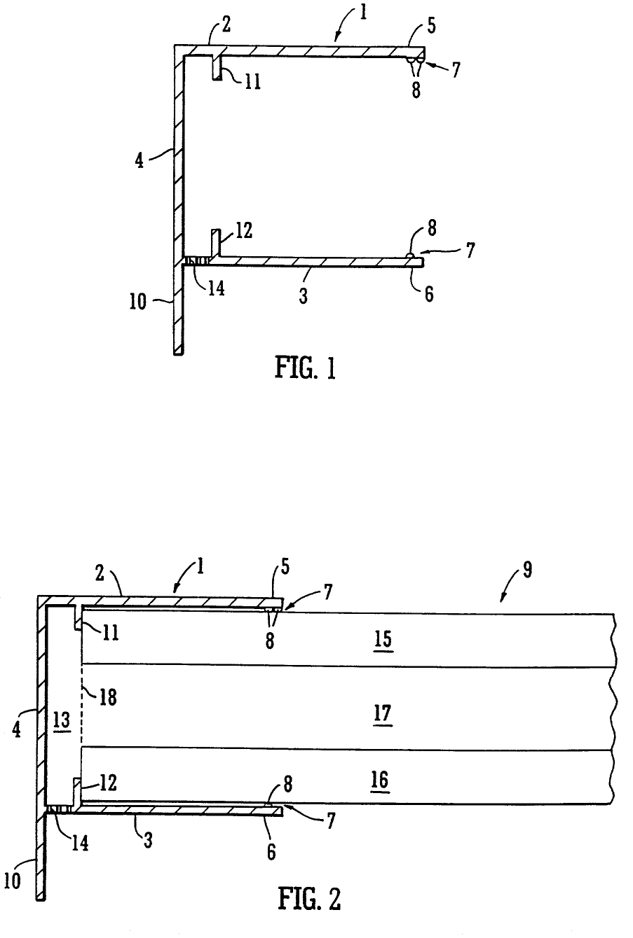

### DETAILED DESCRIPTION

The end closure device 1 is a plastics body of general channel section profile comprising in use an upper arm portion 2 and a generally parallel lower arm portion 3. The upper 2 and lower 3 arm portions are connected at one end by an intermediate bight or floor portion 4. The free ends 5, 6 of both the upper 2 and lower 3 arm portions have gaskets 7 co-extruded onto their inner surfaces adjacent to and not extending beyond the respective free ends 5, 6 of the arm portions 2, 3. The gasket 7 of the upper arm portion 2 is made up of one or two generally parallel rounded beads 8, and the lower arm portion 3 has one rounded bed 8, positioned directly opposite the two beads 8 of the upper arm portion 2. In this arrangement the beads 8 of the upper 2 and lower 3 arm portions co-operate to grip a glazing panel 9 inserted between the two arm portions 2, 3. The beads 8 can be formed from highly plasticized polyvinyl chloride which is compatible with the polycarbonate panel.

The high portion 4 has a lateral extension 10, which in use extends below the level of the lower arm 3. This extension 10 transfers water away from the arm portions to prevent ingress of water between the arm portion 2,3 of the device 1, and the panel 9.

Ribs 11, 12 are situated on the inner surfaces of both the arm portions 2, 3 adjacent to the bight portion 4 to create a ventilation space 13 between the end of the glazing panel 9 and the bight portion 4.

A portion 14 of the lower wall 3 has holes punched or drilled in its surface for water drainage and air circulation.

The glazing panel 9 comprises two skins 15, 16 of polycarbonate material separated by a duct 17. The ends of the glazing panel 9 are normally covered with breather tape 18.

In use, the device 1 is pushed onto the fixed glazing panel 9, the panel 9 being received in the channel of the device between upper and lower arms 2, 3 so that the end of glazing panel 9 abuts against the ribs 11, 12. The resilient beads 8 of the gaskets 7 are compressed and cooperatively grip the opposite panels 15, 16 of the glazing panel 9. The gaskets 7 create a water-tight seal to prevent moisture formed on the upper surface of the arm portions 2, 3 from seeping between the outer surface of the glazing panel 9 and the inner surface of the arm portions 2, 3. Moisture formed within the duct 17 of the glazing panel 9 will pass out of the duct 16 through the breathing tape 18 and into the space 13 within the device 1. The condensation then exits the device I through the holes 14 in the lower arm 3.

By positioning gaskets 7 on the ends of both arm portions, and incorporating the resilient beads 8 into the gasket material 7, it has been demonstrated that a device of the invention is particularly efficient in reducing the amount of moisture entering the glazing panel closure device 1.

The invention is not limited to the embodiment shown. For example, only one rib may be present to hold the glazing panel in place. The gasket material may extend along the length of the arm portions. The number and shape of the resilient beads may differ. The gasket material may be bonded to the body of the device as a separate component. The panels need not be glazing panels. This has been a description of the present invention and the preferred mode of practicing the invention, however, the invention itself should only be defined by the appended claims wherein we claim:

1. A device for closing one end of a glazing panel, the device comprising a body of generally channel cross-sectional shape having two arm portions joined by a bight portion; the arm portions being adapted to overlie the end portions of opposite sides fo the glazing panel, gripping means being present on the inner surface of the arms, each arm gripping the adjacent panel surface, the gripping means generally facing each other and being within the bounds of the device.

2. A device claimed in claim 1 wherein the gripping means are comprised of a water-proof, resilient, gasket material.

3. A device claimed in claim 2 wherein the gasket material comprises a synthetic plastic material.

4. A device claimed in claim 2 wherein the gasket is formed as one or more resilient beads.

5. A device claimed in claim 2 wherein the gasket is co-extruded with the body of the device.

6. A device claimed in claim 2 wherein the gasket is bonded to the body of the device.

7. A device claimed in claim 1, including stop members comprising ribs located on the inner surface of each arm portion close to the bight portion, whereby a space is created between the end of the glazing panel and the bight portion.

8. A device claimed in claim 7 wherein the bight portion has a lateral extension which in use is downwardly extending so that water droplets will fall away from the free ends of the arm portions.

9. A method of closing one end of a glazing panel by receiving the free end of the glazing panel in a device having a body comprising a generally channel cross-sectional shape having two arm portions joined by a bight portion; the arm portions being adapted to overlie the end portions of opposite sides of the glazing panel, gripping means being present on the inner surface of the arms, each arm gripping the adjacent panel surface, the gripping means generally facing each other and being within the bounds of the device, the method comprising engaging the device with an edge portion of the panel until the arm portions overlie the end portions of opposite sides of the panel.
